(19) United States
(12) Patent Application Publication
(10) Pub. No.: US 2026/0195535 A1
(43) Pub. Date: Jul. 9, 2026

(54) MACHINE LEARNING MODEL FOR IDENTIFYING EMERGING TOPICS

(71) Applicant: The PNC Financial Services Group, Inc., Pittsburgh, PA (US)

(72) Inventors: Eric Myers, Pittsburgh, PA (US); Ross O’Connell, Pittsburgh, PA (US)

(73) Assignee: The PNC Financial Services Group, Inc., Pittsburgh, PA (US)

(21) Appl. No.: 19/008,918

(22) Filed: Jan. 3, 2025

(51) Int. Cl. G06F 40/30; G06F 16/34; G06F 16/35; G06F 40/279

(52) U.S. Cl. CPC G06F 40/30; G06F 16/345; G06F 16/35; G06F 40/279

(57) ABSTRACT

Systems and methods identify emerging topics in calls to a call center. A call transcript database stores textual call transcripts of calls to the call center. An emerging topic identification computer system identifies the emerging topics in the calls to the call center based on the textual call transcripts. An embedding module generates call transcript embeddings for the calls from the textual call transcripts, where each call transcript embedding consists of a vector indicative of the contextual significance of one or more words in the call transcript. A clustering module clusters, using a clustering algorithm, calls to the call centers into multiple clusters based on the call transcript embeddings. A domination analysis module identifies one or more emerging topics in calls to the call center based on the multiple clusters. A driving analysis module identifies terminology driving each of the one or more emerging topics. A report generation module generates a report for the emerging topics.

### BACKGROUND

Call centers for enterprise organizations and corporations typically receive a large volume of customer service calls each day. Each call received by a call center is handled by an agent of the call center, with the received calls being divided amongst a number of call center agents, such that each call center agent typically handles a small portion of the total daily received calls on a given day. If an agent identifies an issue or a discussion topic that is reported or discussed in numerous customer calls received by the agent, the agent may then flag the issue and/or discussion topic and report it to the agent's manager and/or another department of the organization. Once an issue and/or discussion topic is identified and reported, the organization can quickly take remedial and/or preventative actions to resolve, prevent, or mitigate occurrence of the issue and/or discussion topic.

In the interest of remedying customer issues as quickly as possible and/or preventing issues from affecting a large number of customers, it is beneficial for the organization to identify new issues and/or discussion topics as early as possible. Typically, a customer issue and/or discussion topic is identified based on the number of occurrences of said issue/discussion topic within a relative time period. If a call center agent receives multiple customer calls within a specified time period, each call concerning or mentioning the same issue, then the agent may flag that issue and report to a manager and/or another department of the organization. For example, an agent may flag and report a customer issue if the agent has received more than 10 calls in a one-week period regarding the same customer issue.

Relying on call center agents to identify and report customer service issues works well for issues that are affecting a large portion of customers of the organization and/or issues that have been previously identified. In other words, it is highly likely that one or more call center agents will each receive numerous calls regarding such a widespread issue, such that at least one agent will quickly identify and report the issue. If an issue was previously identified and reported, agents may already be aware of, and on the lookout for, said issue and may identify and report the issue after a single customer call or small number of customer calls.

However, new or emerging issues and/or discussion topics can be difficult to identify and report, especially those issues and/or topics that do not affect, or have not yet affected, a large number of customers of the organization. For example, an organization that receives a significant amount of customer service calls each day must utilize a large number of customer service agents to field and analyze each received call. Although there might be numerous calls on a given day about an emerging issue, if the issue is only mentioned in a small percentage of the total received calls to the call center, it is possible, if not likely, that no single agent will receive enough calls in a single day to report the issue.

Failure to quickly detect and/or report a new customer service issue can result in adverse consequences for an organization. For example, the organization may experience financial losses resulting from an undetected/unreported fraud issue, customer dissatisfaction and/or reputational harm resulting from an undetected/unreported issue that negatively impacts customer user experience, etc.

### SUMMARY

In one general aspect, the present invention is directed to computer-implemented systems and methods for identifying emerging topics in calls to a call center. In one embodiment, the system comprises a call transcript database for storing textual call transcripts of calls to the call center. The system also comprises an emerging topic identification computer system in communication with the call transcript database, where the emerging topic identification computer system is for identifying the emerging topics in the calls to the call center based on the textual call transcripts. The emerging topic identification computer system can comprise an embedding module for generating call transcript embeddings for the calls from the textual call transcripts, where each call transcript embedding consists of a vector indicative of the contextual significance of one or more words in the call transcript. The emerging topic identification computer system can also comprise a clustering module for clustering, using a clustering algorithm, calls to the call centers into multiple clusters based on the call transcript embeddings. The emerging topic identification computer system can also comprise a domination analysis module for identifying one or more emerging topics in calls to the call center based on the multiple clusters. A driving analysis module can identify terminology driving each of the one or more emerging topics. And the emerging topic identification computer system can comprise a report generation module for generating a report for the emerging topics.

In various implementations, the emerging topic identification computer system can further comprise a call recordings database for storing digital call recordings of the calls to the call center; and a computer-implemented automatic speech recognition system for generating the textual call transcripts from the digital call recordings, such that the textual call transcripts are stored in the call transcript database.

In various implementations, the embedding module is for generating call transcript embeddings for calls to the call center from a first time window and calls to the call center from a second time window, where the first and second time windows do not overlap, and the second time window is more recent than the first time window. In that connection, the clustering module is for clustering the calls to the call centers into the multiple clusters for both the first and second time windows. And the domination analysis module can identify one or more emerging topics in calls to the call center by identifying clusters in the multiple clusters that are dominated by calls from the second time window.

The domination analysis module can use a statistical-based proportions test to identify the clusters in the multiple clusters that are dominated by calls from the second time window, such as a one-sided binomial test. The clustering algorithm can comprise a density-based clustering algorithm. The embedding module can generate the call transcript embeddings from the textual call transcripts using term frequency-inverse document frequency. It can also employ dimension reduction to reduce the dimensions of the call transcript embeddings. The report from the report generation module can comprise, for example, a summary of each emerging topic and, for at least one emerging topic in the report, a link to an audio file that, when played, provides an audible example of a call to the call center pertaining to the at least one emerging topic.

A company, enterprise or organization can use embodiments of the present invention to analyze customer calls received at a customer call center of the organization to identify emerging topics discussed in customer calls received on a given day or any other desired time period. The present invention, in various embodiments can, therefore, provide up-to-date insights to an organization's customer care center team regarding newly identified emerging topics discussed in customer calls to the call center. Embodiments of the present invention can allow customer care center teams to analyze the emerging topics identified by the present invention to quickly recognize and react to customer issues that may otherwise go undetected. These and other potential benefits from embodiments of the present invention will be apparent from the description that follows.

### FIGURES

Various embodiments of the present invention are described herein by way of example in connection with the following figures.

FIG. 1 is a diagram of a computer-implemented customer call processing system according to various embodiments of the present invention.

FIGS. 2 and 3 are cluster plots illustrating an example of the present invention.

FIG. 4 is a block diagram of the emerging topic identification computer system of FIG. 1 according to various embodiments of the present invention.

The patent or application file contains at least one drawing executed in color. Copies of this patent or patent application publication with color drawing(s) will be provided by the Office upon request and payment of the necessary fee.

### DESCRIPTION

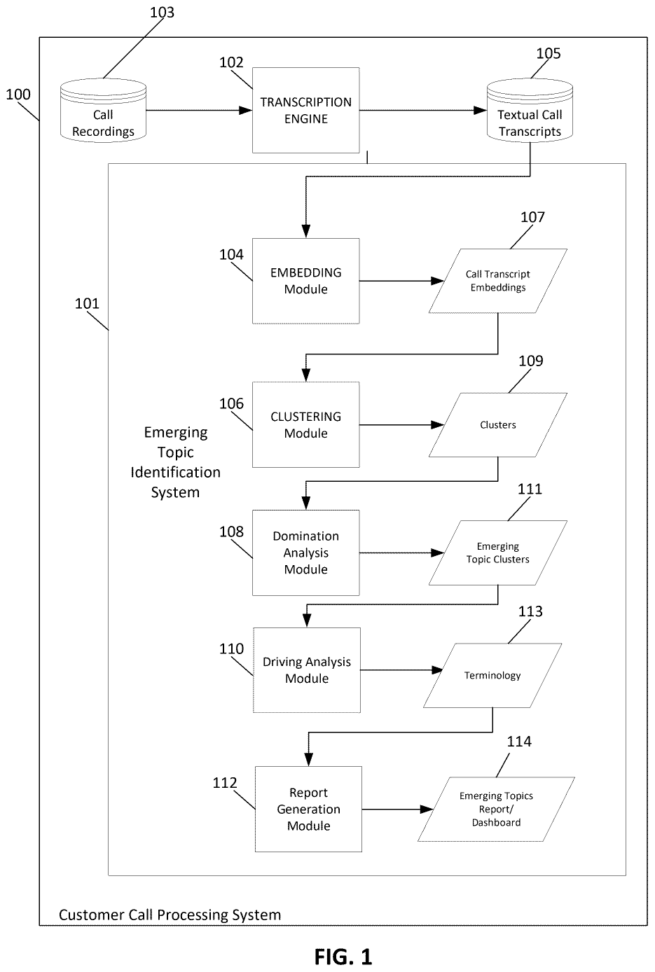

FIG. 1 depicts a system 100 for processing customer calls to a customer call center to identify emerging topics, according to various embodiments of the present invention. According to various embodiments, the customer call processing system 100 can comprise one or more databases, such as databases 103, 105. The first, or call recordings, database 103 can store audio recordings of customer calls received by the call center of the organization; and the second, or call transcript, database 105 can store text files of textual transcripts of each recorded customer call received by the call center.

Specialized software can be installed on the call center's telephone system or integrated with VoIP services to record incoming or outgoing calls to the call center. Call center platforms such as Genesys, NICE, Five9, and Zendesk have native call recording functionalities. Also, cloud-based platforms (e.g., AWS Connect, Twilio) offer scalable and secure recording capabilities. Calls to/from the call center can be routed through a PBX (Private Branch Exchange) or VoIP systems that support recording the calls. The recordings can be stored as audio files, such as in compressed formats like MP3, WAV, or AAC to save space. The database 103 can be on-premises (e.g., part of local servers of the organization), in the cloud (e.g., AWS or Azure), or a combination of both.

In accordance with various embodiments, the customer call processing system 100 can comprise, or communicate with, a transcription engine 102. The transcription engine 102 can transcribe recordings of calls stored in the call recordings database 103, with text files generated therefrom being stored in the call transcript database 105. In that connection, the transcription engine might comprise speech-to-text transcription software. The transcriptions can be generated in text files (such as TXT, JSON, CSV, DOCX, or PDF files). Metadata for calls can also be stored with the transcripts, the metadata including, for example, call ID, timestamp, and agent. The call transcript database 105 also could be part of an on-premises computer network of the organization and/or in cloud storage. The transcription files could also be encrypted (e.g., AES-256 encryption).

In various embodiments, the customer call processing system 100 also comprises an emerging topic identification system 101. The emerging topic identification system 101 can comprise, as shown in the example of FIG. 1, modules 104, 106, 108, 110, 112 to embed, cluster, and analyze transcripts of customer call recordings to identify emerging topics. In some embodiments, the modules 104, 106, 108, 110, 112 can comprise software for executing any suitable data retrieval, storage, processing, and/or analysis techniques, algorithms, etc. The modules 104, 106, 108, 110, 112 can be executed by processor(s) of the emerging topic identification system 101. In that sense, the emerging topic identification system 101 can be implemented by one or more networked computers (e.g., servers) with memory (e.g., RAM for active use, ROM for permanent storage) for storing the software modules 104, 106, 108, 110, 112 and one or more processors (not shown) for executing the software of the modules 104, 106, 108, 110, 112. The computer(s) for the emerging topic identification system 101 could be part of an on-premises network or part of a cloud network or a hybrid thereof. A Kubernetes container(s) could also be used for the emerging topic identification system 101.

In brief, and as explained in greater detail below, an embedding module 104 can process the textual transcript files of the customer call recording stored in the call transcript database 105 to generate call transcript embeddings 107 for each customer call transcript. A clustering module 106 can process the embeddings 107 to generate clusters 109 of topics for the calls. A domination analysis module 108 can then analyze the clusters 109 to determine, based on criteria described below, whether a cluster 109 qualifies as an emerging topic 111. In some embodiments, the organization can operate the emerging topic identification system 101 to identify the emerging topics 111 on a predetermined interval or schedule, such as daily (or every day that the call center is open).

In some embodiments, emerging topics can be identified by comparing the clusters 109 for a given day (e.g., the “day of interest,” which could be current day or the previous day) to the clusters 109 for a comparison day (e.g., a day prior to the day on interest). As such, the embedding module 104 can generate the embeddings 107 for both the day of interest and the comparison day. The call embeddings 107 for the comparison day could have been previously generated when the comparison day was the day on interest. As such, the embeddings 107 from each day can be stored in a database (not shown) for later use (e.g., when used as the comparison day). The comparison by the domination analysis can also be more granular than merely the day of interest to the comparison call. For example, for comparison purposes, the call topic clusters 109 could be further filtered based on additional criteria in the call transcript metadata, such as geographical location from which the calls were received (e.g., area code, cell tower, SIP headers in VoIP calls, caller-provided information), a time window in which the calls were received, an age of the accounts of the account holders that made the calls, the duration of the calls, etc. In various embodiments, the embedding module 104 combines the call transcripts from both days into a single dataset to be processed by the embedding module 104.

The day of interest preferably is a recent day as the goal is to discover and address emerging topics. As such, the day of interest could be the current day or an immediately prior (business) day. The comparison day preferably occurred prior to the day of interest. For example, the comparison day can be the day before the day of interest, the day one week prior to the day of interest, or any other day prior to the day of interest that is suitable for identifying emerging topics. While a comparison day that is one day prior to the day of interest can identify the newest or most recently emerging topics, a comparison day that occurred one week prior to the day of interest can be more beneficial in avoiding the identification of emerging topics that are related to week-to-week system updates that may be implemented by the organization.

In some embodiments, the embedding module 104 generates the embeddings 107 for each customer call transcript for the day of interest and the comparison day using a term frequency-inverse document frequency (“TF-IDF”) data processing technique. In various embodiments, the TF-IDF algorithm counts the frequency of occurrences of each word in its vocabulary within each transcript, i.e., the “term frequency.” This can result, for each transcript, in a vector that has as many elements as there are words in the relevant vocabulary, with each element in the vector being the number of occurrences of the corresponding word in the vocabulary. The vector elements can then be multiplied by an inverse document frequency, e.g., the log (N/M), where N is the number of transcripts in the dataset and M is the number of transcripts in the dataset that contain the term. In various embodiments, normalization (e.g., L2 normalization) can be applied to each vector. In various embodiments, the embedding module 107 uses a word vocabulary comprised of the most common words contained in the call transcripts. The vocabulary can comprise, for example, 20,000 words.

In some embodiments, the original embeddings 107 generated by the embedding module 104 can comprise high-dimensional vectors that are unsuitable for various data clustering and/or visualization techniques. For example, if a 20,000-word vocabulary is used, the vectors would have 20,000 dimensions. Accordingly, in various embodiments, the embedding module 104 can reduce the dimensions of the embeddings 107 to a lower-dimensional embedding vector that is more suitable for various data clustering techniques, such as 2 to 100 dimensions. For example, the embedding module 104 can process the originally generated embeddings 107 using a dimension reduction technique, such as Uniform Manifold Approximation (“UMAP”), to reduce each embedding 107 to a six-dimensional (“6D”) embedding. The UMAP process can create a fuzzy graph representation of the high-dimensional data by, for example, calculating pairwise distances between datapoints for each vector, calculating a local radius for each data point based on its nearest neighbors, and defining a fuzzy set for each data point where the membership strength of neighboring points is determined based on the computed distances. This step essentially defines a weighted graph where edges represent the strength of connections between points. Once the high-dimensional structure is represented as a graph, the UMAP process can learn a lower-dimensional embedding. The UMAP algorithm can optimize the placement of points in the lower-dimensional space by minimizing the divergence between the fuzzy topological structure in the high-dimensional space and a similar structure in the low-dimensional space. The optimization minimizes the cross-entropy between the two fuzzy topologies, ensuring that similar points in the high-dimensional space remain close in the low-dimensional embedding. The UMAP process can apply stochastic gradient descent (SGD) to minimize the difference between the high-dimensional and low-dimensional graphs.

After the embedding module 104 has generated the reduced-dimension call transcript embedding 107 for each call transcript in the dataset, the clustering module 106 can cluster the call transcript embeddings 107 into two or more clusters. In some embodiments, the clustering module 106 generates the clusters 109 using a density-based clustering algorithm, such as HDBScan clustering. Density-based clustering does not rely on any assumption about the number of clusters 109 that should be generated, the geometry of a given cluster 109, or the relative size of a cluster 109. Density-based clustering identifies high-density areas within a dataset, i.e., groups of similar embeddings 107 that contain at least a minimum threshold number of similar embeddings 107. For example, in various embodiments, a cluster 109 can comprise at least N embeddings 107, where N is selected based on how likely smaller clusters are to yield meaningful information. For example, in various embodiments, N=40. Other suitable clustering algorithms could also be used in other embodiments, such as centroid-based clustering algorithms, such as k-means or expectation-maximization (EM) clustering algorithms. A difference between density-based clustering, such as HDBScan, and centroid-based clustering is that centroid-based clustering ordinarily associates each observation—in this case the call transcript embeddings 107—with a cluster. Density-based clustering does not typically associate each observation (e.g., call transcript embedding 107) with a cluster, e.g. observations in low-density regions can be unclustered with density-based clustering. Accordingly, in some embodiments (e.g., density-based clustering), the clusters 109 do not include all of the call transcript embeddings 107, whereas in other embodiments (e.g., centroid-based clustering), all of the embeddings 107 are classified to a cluster 109. In some embodiments, each cluster 109 must contain at least a minimum threshold of call transcript embeddings 107.

In accordance with various embodiments, once the clustering module 106 has generated the clusters 109, the domination analysis module 108 analyzes the clusters 109 to determine if a cluster 109, according to specified criteria, is dominated by call transcripts from the day of interest (as opposed to being dominated by the comparison day or not be dominated by either day). If a cluster is dominated by call transcripts from the day of interest, the topic for the cluster can be considered an emerging topic for the call center.

In accordance with various embodiments, to assess domination for a given cluster, the domination analysis module 108 can use a one-sided binomial test. In various embodiments, therefore, the hypothesis of calls from the day of interest (HA), can be set to be greater than some threshold value that is greater than 0.5, such as 0.65, i.e., HA: p>p₀, where p₀ is the expected value (fraction) of calls from the day of interest. Assuming that n_{A} and n_{B} are the number of calls from the day of interest and the number of calls from the comparison day, respectively, a binomial mass function (PMF) or cumulative distribution function (CDF) can be used to compute the p-value, e.g., p-value=P (X>n_{A}|n, p₀) where X~Binomial (n, p₀) and n=n_{A}+n_{B}. For example, the p-value can be computed as 1−CDF (X=n_{A}−1;n,p₀) where CDF is the cumulative distribution function of the binomial distribution. The p-value can then be compared with a significance level hyperparameter, α=0.10 for example, to determine if the given cluster is dominated by calls from the day of interest; that is, for example, if the p-value ≥α, then the cluster can be considered to dominated by calls from the day of interest. This process can be performed for each cluster 109 to determine whether each cluster 109 is dominated by the day of interest.

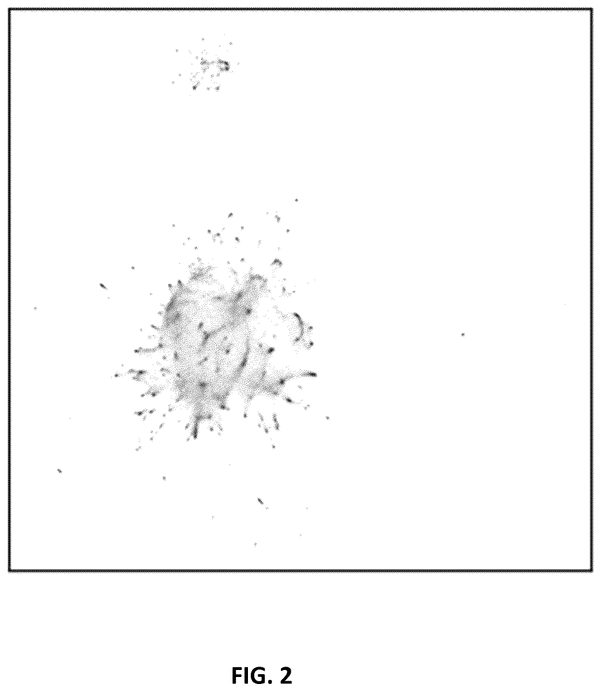

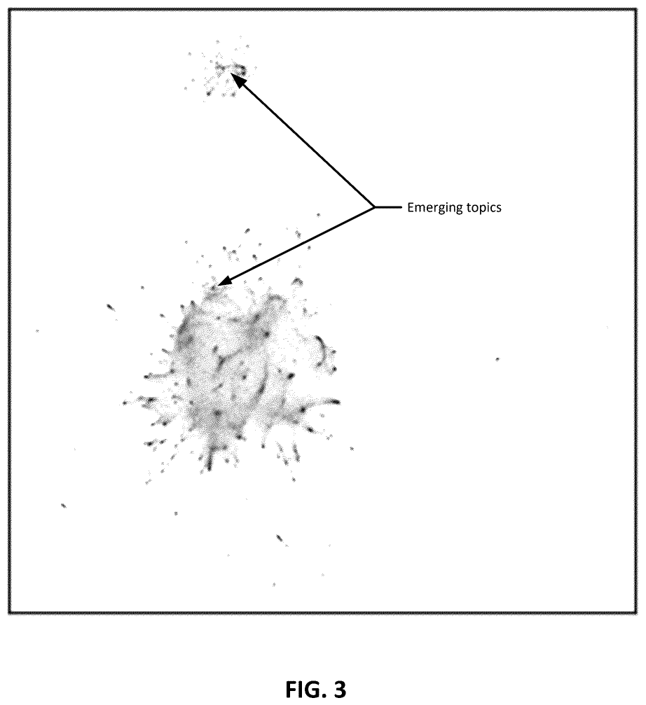

An example of this process is illustrated by the two plots shown in FIGS. 2 and 3, which compare transcripts from a comparison day to a day of interest. FIG. 2 plots the call transcript embeddings 107 (created using UMAP as described) with transcripts from the comparison day in blue and transcripts from day of interest in red. FIG. 3 shows clustering of the embeddings 107 using HDBScan. Note that the clustering was performed on a 6D embedding, not the 2D embedding used for plotting in FIG. 2. Unclustered points are shown in black, clustered points are shown in blue, and clustered points that are part of an emerging topic are shown in red.

Referring back to FIG. 1, once the domination analysis module 108 has identified the emerging topic clusters 111, a driving analysis module 110 can identify the terminology, i.e., words, phrases, etc., that are driving the emerging topic clusters 111. The driving analysis module 110 can analyze the call transcripts for each emerging topic cluster 111 to identify terminology that is driving the emerging topic cluster 111, e.g., identify distinguishing words or phrases that are statistically or contextually significant within a given emerging topic cluster 111 compared to other clusters 109. For example, sentence embeddings (e.g., Sentence-BERT) can be used to identify semantically related text in the call transcripts in an emerging topic cluster 111. Also, a fine-tuned, pre-trained language model can be used to highlight differences between the emerging topic clusters 111. The output of this analysis can be a ranked list 113 of words, phrases, or themes that uniquely characterize each emerging topic cluster 111, helping to understand what drives each emerging topic cluster's formation.

A report generation module 112 of the emerging topic identification system 101 can generate a report or dashboard 114 for the identified emerging topics. The report can be a file that is served by the emerging topic identification system 101 to end users, e.g., analysts within the organization and/or call center agents. In that connection, the report could be, for example, a web-based dashboard that is made available via a web server or application server of the organization. In some embodiments, the report 114 can be captured in one or more electronic files, such as a spreadsheet, a text file, a JSON file, an HTML file, or a word document that identifies the key word(s)/phrases(s) for each emerging topic cluster 111. The report/dashboard 114 can also include, for example: a summary of each emerging topic cluster 111 (e.g., high-level description of each cluster's theme or topic); key example sentences or excerpts from some of the call transcripts in the emerging topic cluster 111 illustrating the topic; a visualization including, for example, graphs or word clouds for a visual summary of dominant terms; and/or metadata, such as TF-IDF scores for the distinguishing terms. The summaries could be created using pre-trained language models (e.g., GPT or BERT summarization tools) to automatically generate summaries from the text data. The LLM could be locally hosted by the organization's IT system or, where a third party LLM is used, the report generation module 112 may communicate with the third party LLM via an API. Similarity measures (e.g., cosine similarity) or clustering algorithms, like k-medoids, can be used within each emerging topic cluster 111 to find the representative sentences or excerpts. Python libraries and/or visualization platforms can be used to generate the visualizations. In embodiments utilizing a dashboard, any suitable dashboard building tool could be used, such as Grafana or Tableau.

Audio files for the key examples could also be provided in the report/dashboard 114 so that the analyst(s) and/or call center agents could audibly hear the examples. To do this, for example, the call transcripts can be aligned timewise with the recordings. The timestamps for the key examples can be extracted and then audio processing tools (e.g., FFmpeg) can be used to cut the original audio recording into smaller files based on the timestamps. Each snippet can be saved as an individual audio file, preferably in a compressed format like .mp3 for ease of sharing. The snippets can be stored in the call transcript database 103 as well or another database. The report (e.g., dashboard) 114 from the report generation module 112 can include a link to the file in the database 103 for the snippet with the key example. Clicking on the link can launch an audio player in an end-user's computer device to play audibly the selected key example snippet.

The report/dashboard 114 can be shared with call center agents of the organization. As such, the analyst(s) and/or the call center agents can determine appropriate action to be taken in the event that future calls involve any of the newly identified emerging topics 111. Also, for example, when an emerging topic 111 pertains to a fraud issue for the organization, that emerging topic can be provided, or otherwise communicated, to a fraud analysis team within the organization, which can generate displays of current leading indicators of fraud, which can be updated daily to manage the financial and reputational risks to the organization that are associated with fraud.

As mentioned before, the call center can record calls to it. When a customer calls the call center via a toll-free number or direct line, the recording can be triggered, such that the call center automatically starts recording upon call connection. The call center's system might play a notification indicating that the call is being recorded for quality assurance. The call audio is recorded and saved in the database 103 in real time, with metadata (e.g., caller ID, agent ID, timestamps) attached to the file.

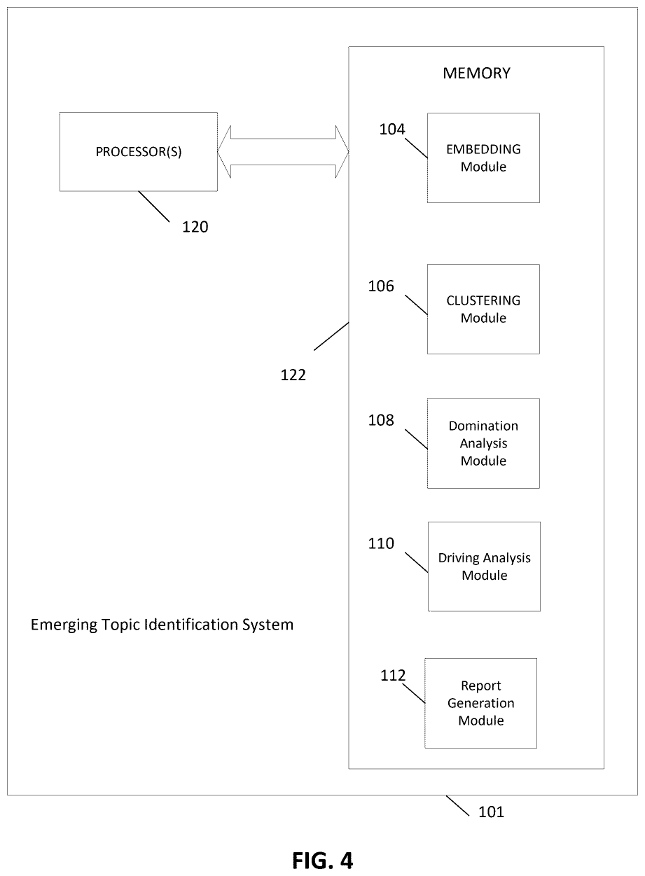

FIG. 4 is a block diagram of the emerging topic identification system 101. The example of FIG. 4 shows that the emerging topic identification system 101 can comprise one or more processors 120 and one or more computer memories 122. For sake of simplicity, and without loss of generalization, the illustrated emerging topic identification system 101 shows one processor 120 and one computer memory 120. The processor(s) 120 can comprise one or more CPUs of GPUs. The memory 122 includes primary memory (e.g., memory directly accessible by the processor(s), such as RAM) and/or secondary memory (e.g., memory that is not directly accessible by the processors(s), such as ROM, flash, HDD, SSD, etc.). The various modules 104, 106, 108, 110, 112 store non-transitory computer instructions (e.g., software) that, when executed by the processor(s) 120, cause the processor(s) 120 to identifying the emerging call center topics as described herein. The emerging topic identification system 101 may be implemented as one or a number of networked computer devices, e.g., servers, laptops, PCs, and so on. The emerging topic identification system 101 is communicatively connected or subscribed to the call transcript database 105 and the analytics system 112 via an electronic data network(s) of the organization.

The software for the modules described herein and other computer functions described herein may be implemented in computer software using any suitable computer programming language (e.g., .NET, C, C++, Python) and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

In one general aspect, therefore, the present invention is directed to systems and methods system for identifying emerging topics in calls to a call center. In various embodiments, the system comprises a call transcript database for storing textual call transcripts of calls to the call center, and an emerging topic identification computer system in communication with the call transcript database for identifying emerging topics in the calls to the call center based on the textual call transcripts. The emerging topic identification computer system comprises: an embedding module for generating call transcript embeddings for the calls from the textual call transcripts, wherein each call transcript embedding a vector indicative of a contextual significance of one or more words in the call transcript; a clustering module for clustering, using a clustering algorithm, calls to the call centers into multiple clusters based on the call transcript embeddings; a domination analysis module for identifying one or more emerging topics in calls to the call center based on the multiple clusters; a driving analysis module for identifying terminology driving each of the one or more emerging topics; and a report generation module for generating a report for the emerging topics.

In various implementations, the system can further comprise: a call recordings database for storing digital call recordings of the calls to the call center; and a computer-implemented automatic speech recognition system for generating the textual call transcripts from the digital call recordings, wherein the textual call transcripts are stored in the call transcript database.

In various implementations, the embedding module can generate call transcript embeddings for calls to the call center from a first time window and calls to the call center from a second time window, where the first and second time windows do not overlap, and the second time window is more recent than the first time window; the clustering module is for clustering the calls to the call centers into the multiple clusters for both the first and second time windows; and the domination analysis module is for identifying one or more emerging topics in calls to the call center by identifying clusters in the multiple clusters that are dominated by calls from the second time window. In various implementations, the domination analysis module can use a statistical-based proportions test to identify the clusters in the multiple clusters that are dominated by calls from the second time window. In various implementations, the proportions test can comprise a one-sided binomial test to identify the clusters in the multiple clusters that are dominated by calls from the second time window. Also, in various implementations, the clustering algorithm comprises a density-based clustering algorithm or a centroid-based clustering algorithm. In various implementations, the embedding module generates the call transcript embeddings from the textual call transcripts using term frequency-inverse document frequency. In various implementations, the embedding module further uses dimensional reduction to reduce dimensions of the call transcript embeddings.

In various implementations, the clustering algorithm comprises a density-based clustering algorithm; and the embedding module generates the call transcript embeddings from the textual call transcripts using term frequency-inverse document frequency and dimension reduction.

In various implementations, the report from the report generation module comprises: a summary of each emerging topic; and for at least one emerging topic in the report, a link to an audio file that, when played, provides an audible example of a call to the call center pertaining to the at least one emerging topic.

In another general aspect, the emerging topic identification computer system is configured to: generate call transcript embeddings for the calls from the textual call transcripts, wherein each call transcript embedding a vector indicative of a contextual significance of one or more words in the call transcript; cluster, using a clustering algorithm, calls to the call centers into multiple clusters based on the call transcript embeddings; identify one or more emerging topics in calls to the call center based on the multiple clusters; identify terminology driving each of the one or more emerging topics; and generate a report for the emerging topics.

In various implementations, the system can further comprise: a call recordings database for storing digital call recordings of the calls to the call center; and a computer-implemented automatic speech recognition system for generating the textual call transcripts from the digital call recordings, where the textual call transcripts are stored in the call transcript database. Also, the emerging topic identification computer system can be configured to: generate, using term frequency-inverse document frequency and dimension reduction, call transcript embeddings for calls to the call center from a first time window and calls to the call center from a second time window, where the first and second time windows do not overlap, and the second time window is more recent than the first time window; cluster, using a density-based clustering algorithm, the calls to the call centers into the multiple clusters for both the first and second time windows; and identify, using a statistical-based proportions test, one or more emerging topics in calls to the call center by identifying clusters in the multiple clusters that are dominated by calls from the second time window. Also, the report can comprise a summary of each emerging topic; and for at least one emerging topic in the report, a link to an audio file that, when played, provides an audible example of a call to the call center pertaining to the at least one emerging topic.

In another general aspect, the emerging topic identification computer system can comprise: one or more processors; and computer memory in communication with the one or more processors. The computer memory stores instructions that, when executed by the one or more processors, cause the one or more processors to: generate call transcript embeddings for the calls from the textual call transcripts, wherein each call transcript embedding is a vector indicative of a contextual significance of one or more words in the call transcript; cluster, using a clustering algorithm, calls to the call centers into multiple clusters based on the call transcript embeddings; identify one or more emerging topics in calls to the call center based on the multiple clusters; identify terminology driving each of the one or more emerging topics; and generate a report for the emerging topics.

In various implementations, the computer memory stores instructions that when executed by the one or more processors cause the one or more processors to: generate, using term frequency-inverse document frequency and dimension reduction, call transcript embeddings for calls to the call center from a first time window and calls to the call center from a second time window, where the first and second time windows do not overlap, and the second time window is more recent than the first time window; cluster, using a density-based clustering algorithm, the calls to the call centers into the multiple clusters for both the first and second time windows; and identify, using a statistical-based proportions test, one or more emerging topics in calls to the call center by identifying clusters in the multiple clusters that are dominated by calls from the second time window.

In another general aspect, the present invention is directed to a non-transitory computer-readable medium that when executed by a set of one or more processors causes the set of one or more processors to: generate, from textual call transcripts stored in a call transcript database, call transcript embeddings for calls to a call center from the textual call transcripts, where each call transcript embedding comprises a vector indicative of a contextual significance of one or more words in the call transcript; cluster, using a clustering algorithm, calls to the call centers into multiple clusters based on the call transcript embeddings; identify one or more emerging topics in calls to the call center based on the multiple clusters; identify terminology driving each of the one or more emerging topics; and generate a report for the emerging topics.

In various implementations, the non-transitory computer-readable medium, when executed by the set of one or more processors further causes the set of one or more processors to: generate, using term frequency-inverse document frequency and dimension reduction, call transcript embeddings for calls to the call center from a first time window and calls to the call center from a second time window, where the first and second time windows do not overlap, and the second time window is more recent than the first time window; cluster, using a density-based clustering algorithm, the calls to the call centers into the multiple clusters for both the first and second time windows; identify, using a statistical-based proportions test, one or more emerging topics in calls to the call center by identifying clusters in the multiple clusters that are dominated by calls from the second time window; and generate the report such that the report comprises: a summary of each emerging topic; and for at least one emerging topic in the report, a link to an audio file that, when played, provides an audible example of a call to the call center pertaining to the at least one emerging topic.

A method according to various embodiments of the present invention can comprise the steps of storing, in a call transcript database, textual call transcripts of calls to the call center; and identifying, with an emerging topic identification computer system that is in communication with the call transcript database, emerging topics in the calls to the call center based on the textual call transcripts. The step of identifying the emerging topics can comprise: generating call transcript embeddings for the calls from the textual call transcripts, where each call transcript embedding is a vector indicative of a contextual significance of one or more words in the call transcript; clustering, using a clustering algorithm, calls to the call centers into multiple clusters based on the call transcript embeddings; identifying one or more emerging topics in calls to the call center based on the multiple clusters; identify terminology driving each of the one or more emerging topics; and generating a report for the emerging topics.

In various implementations, the method further comprises the steps of storing, by a call recordings database, digital call recordings of the calls to the call center; and generating, with a computer-implemented automatic speech recognition system, the textual call transcripts from the call recordings, where the textual call transcripts are stored in the call transcript database.

In various implementations, generating the call transcript embeddings comprises generating call transcript embeddings for calls to the call center from a first time window and calls to the call center from a second time window, wherein the first and second time windows do not overlap, and the second time window is more recent than the first time window; clustering the calls comprises clustering the calls to the call centers into the multiple clusters for both the first and second time windows; and identifying the one or more emerging topics in calls to the call center comprises identifying clusters in the multiple clusters that are dominated by calls from the second time window.

In various implementations, the step of identifying the one or more emerging topics comprises using a statistical-based proportions test to identify the clusters in the multiple clusters that are dominated by calls from the second time window. Also, the proportions test can comprise a one-sided binomial test to identify the clusters in the multiple clusters that are dominated by calls from the second time window.

In various implementations, the step of generating the call transcript embeddings from the textual call transcripts comprising using term frequency-inverse document frequency. Also, the step of generating the call transcript embeddings can further comprise reducing dimensions of the call transcript embeddings.

In various implementations, the clustering algorithm comprises a density-based clustering algorithm, and the step of generating the call transcript embeddings from the textual call transcripts comprises using term frequency-inverse document frequency and dimension reduction.

In various implementations, the step of generating the report comprises generating the report such that the report comprises: a summary of each emerging topic; and for at least one emerging topic in the report, a link to an audio file that, when played, provides an audible example of a call to the call center pertaining to the at least one emerging topic.

Numerous benefits have been described that result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A system for identifying emerging topics in calls to a call center, the system comprising:
a call transcript database for storing textual call transcripts of calls to the call center; and
an emerging topic identification computer system in communication with the call transcript database for identifying emerging topics in the calls to the call center based on the textual call transcripts, wherein the emerging topic identification computer system comprises:
an embedding module for generating call transcript embeddings for the calls from the textual call transcripts, wherein each call transcript embedding a vector indicative of a contextual significance of one or more words in the call transcript;
a clustering module for clustering, using a clustering algorithm, calls to the call centers into multiple clusters based on the call transcript embeddings;
a domination analysis module for identifying one or more emerging topics in calls to the call center based on the multiple clusters;
a driving analysis module for identifying terminology driving each of the one or more emerging topics; and
a report generation module for generating a report for the emerging topics.

2. The system of claim 1, further comprising:
a call recordings database for storing digital call recordings of the calls to the call center; and
a computer-implemented automatic speech recognition system for generating the textual call transcripts from the digital call recordings, wherein the textual call transcripts are stored in the call transcript database.

3. The system of claim 2, wherein:
the embedding module is for generating call transcript embeddings for calls to the call center from a first time window and calls to the call center from a second time window, wherein the first and second time windows do not overlap, and the second time window is more recent than the first time window;
the clustering module is for clustering the calls to the call centers into the multiple clusters for both the first and second time windows; and
the domination analysis module is for identifying one or more emerging topics in calls to the call center by identifying clusters in the multiple clusters that are dominated by calls from the second time window.

4. The system of claim 3, wherein the domination analysis module uses a statistical-based proportions test to identify the clusters in the multiple clusters that are dominated by calls from the second time window.

5. The system of claim 4, wherein the proportions test comprises a one-sided binomial test to identify the clusters in the multiple clusters that are dominated by calls from the second time window.

6. The system of claim 4, wherein the clustering algorithm comprises a density-based clustering algorithm.

7. The system of claim 4, wherein the clustering algorithm comprises a centroid-based clustering algorithm.

8. The system of claim 4, wherein the embedding module generates the call transcript embeddings from the textual call transcripts using term frequency-inverse document frequency.

9. The system of claim 8, wherein the embedding module further uses dimensional reduction to reduce dimensions of the call transcript embeddings.

10. The system of claim 5, wherein:
the clustering algorithm comprises a density-based clustering algorithm; and
the embedding module generates the call transcript embeddings from the textual call transcripts using term frequency-inverse document frequency and dimension reduction.

11. The system of claim 10, wherein the report from the report generation module comprises:
a summary of each emerging topic; and
for at least one emerging topic in the report, a link to an audio file that, when played, provides an audible example of a call to the call center pertaining to the at least one emerging topic.

12. A system for identifying emerging topics in calls to a call center, the system comprising:
a call transcript database for storing textual call transcripts of calls to the call center; and
an emerging topic identification computer system in communication with the call transcript database for identifying emerging topics in the calls to the call center based on the textual call transcripts, wherein the emerging topic identification computer system is configured to:
generate call transcript embeddings for the calls from the textual call transcripts, wherein each call transcript embedding a vector indicative of a contextual significance of one or more words in the call transcript;
cluster, using a clustering algorithm, calls to the call centers into multiple clusters based on the call transcript embeddings;
identify one or more emerging topics in calls to the call center based on the multiple clusters;
identify terminology driving each of the one or more emerging topics; and
generate a report for the emerging topics.

13. The system of claim 12, wherein:
the system further comprises:
a call recordings database for storing digital call recordings of the calls to the call center; and
a computer-implemented automatic speech recognition system for generating the textual call transcripts from the digital call recordings, wherein the textual call transcripts are stored in the call transcript database; and
the emerging topic identification computer system is configured to:
generate, using term frequency-inverse document frequency and dimension reduction, call transcript embeddings for calls to the call center from a first time window and calls to the call center from a second time window, wherein the first and second time windows do not overlap, and the second time window is more recent than the first time window;
cluster, using a density-based clustering algorithm, the calls to the call centers into the multiple clusters for both the first and second time windows; and
identify, using a statistical-based proportions test, one or more emerging topics in calls to the call center by identifying clusters in the multiple clusters that are dominated by calls from the second time window; and
the report comprises:
a summary of each emerging topic; and
for at least one emerging topic in the report, a link to an audio file that, when played, provides an audible example of a call to the call center pertaining to the at least one emerging topic.

14. A system for identifying emerging topics in calls to a call center, the system comprising:
a call transcript database for storing textual call transcripts of calls to the call center; and
an emerging topic identification computer system in communication with the call transcript database for identifying emerging topics in the calls to the call center based on the textual call transcripts, wherein the emerging topic identification computer system comprises:
one or more processors; and
computer memory in communication with the one or more processors, wherein the computer memory stores instructions that, when executed by the one or more processors, cause the one or more processors to:
generate call transcript embeddings for the calls from the textual call transcripts, wherein each call transcript embedding is a vector indicative of a contextual significance of one or more words in the call transcript;
cluster, using a clustering algorithm, calls to the call centers into multiple clusters based on the call transcript embeddings;
identify one or more emerging topics in calls to the call center based on the multiple clusters;
identify terminology driving each of the one or more emerging topics; and
generate a report for the emerging topics.

15. The system of claim 14, wherein:
the system further comprises:
a call recordings database for storing digital call recordings of the calls to the call center; and
a computer-implemented automatic speech recognition system for generating the textual call transcripts from the digital call recordings, wherein the textual call transcripts are stored in the call transcript database; and
the computer memory stores instructions that when executed by the one or more processors cause the one or more processors to:
generate, using term frequency-inverse document frequency and dimension reduction, call transcript embeddings for calls to the call center from a first time window and calls to the call center from a second time window, wherein the first and second time windows do not overlap, and the second time window is more recent than the first time window;
cluster, using a density-based clustering algorithm, the calls to the call centers into the multiple clusters for both the first and second time windows; and
identify, using a statistical-based proportions test, one or more emerging topics in calls to the call center by identifying clusters in the multiple clusters that are dominated by calls from the second time window; and
the report comprises:
a summary of each emerging topic; and
for at least one emerging topic in the report, a link to an audio file that, when played, provides an audible example of a call to the call center pertaining to the at least one emerging topic.

16. A non-transitory computer-readable medium that when executed by a set of one or more processors causes the set of one or more processors to:
generate, from textual call transcripts stored in a call transcript database, call transcript embeddings for calls to a call center from the textual call transcripts, wherein each call transcript embedding comprises a vector indicative of a contextual significance of one or more words in the call transcript;
cluster, using a clustering algorithm, calls to the call centers into multiple clusters based on the call transcript embeddings;
identify one or more emerging topics in calls to the call center based on the multiple clusters;
identify terminology driving each of the one or more emerging topics; and
generate a report for the emerging topics.

17. The non-transitory computer-readable medium of claim 16, when executed by the set of one or more processors further causes the set of one or more processors to:
generate, using term frequency-inverse document frequency and dimension reduction, call transcript embeddings for calls to the call center from a first time window and calls to the call center from a second time window, wherein the first and second time windows do not overlap, and the second time window is more recent than the first time window;
cluster, using a density-based clustering algorithm, the calls to the call centers into the multiple clusters for both the first and second time windows;
identify, using a statistical-based proportions test, one or more emerging topics in calls to the call center by identifying clusters in the multiple clusters that are dominated by calls from the second time window; and
generate the report such that the report comprises:
a summary of each emerging topic; and
for at least one emerging topic in the report, a link to an audio file that, when played, provides an audible example of a call to the call center pertaining to the at least one emerging topic.

18. A computer-implemented method for identifying emerging topics in calls to a call center, the method comprising:
storing, in a call transcript database, textual call transcripts of calls to the call center; and
identifying, with an emerging topic identification computer system that is in communication with the call transcript database, emerging topics in the calls to the call center based on the textual call transcripts, wherein identifying the emerging topics comprises:
generating call transcript embeddings for the calls from the textual call transcripts, wherein each call transcript embedding is a vector indicative of a contextual significance of one or more words in the call transcript;
clustering, using a clustering algorithm, calls to the call centers into multiple clusters based on the call transcript embeddings;
identifying one or more emerging topics in calls to the call center based on the multiple clusters;
identify terminology driving each of the one or more emerging topics; and
generating a report for the emerging topics.

19. The method of claim 18, further comprising:
storing, by a call recordings database, digital call recordings of the calls to the call center; and
generating, with a computer-implemented automatic speech recognition system, the textual call transcripts from the call recordings, wherein the textual call transcripts are stored in the call transcript database.

20. The method of claim 19, wherein:
generating the call transcript embeddings comprises generating call transcript embeddings for calls to the call center from a first time window and calls to the call center from a second time window, wherein the first and second time windows do not overlap, and the second time window is more recent than the first time window;
clustering the calls comprises clustering the calls to the call centers into the multiple clusters for both the first and second time windows; and
identifying the one or more emerging topics in calls to the call center comprises identifying clusters in the multiple clusters that are dominated by calls from the second time window.

21. The method of claim 20, wherein identifying the one or more emerging topics comprises using a statistical-based proportions test to identify the clusters in the multiple clusters that are dominated by calls from the second time window.

22. The method of claim 21, wherein the proportions test comprises a one-sided binomial test to identify the clusters in the multiple clusters that are dominated by calls from the second time window.

23. The method of claim 21, wherein the clustering algorithm comprises a density-based clustering algorithm.

24. The method of claim 21, wherein generating the call transcript embeddings from the textual call transcripts comprising using term frequency-inverse document frequency.

25. The method of claim 24, wherein generating the call transcript embeddings further comprises reducing dimensions of the call transcript embeddings.

26. The system of claim 22, wherein:
the clustering algorithm comprises a density-based clustering algorithm; and
generating the call transcript embeddings from the textual call transcripts comprises using term frequency-inverse document frequency and dimension reduction.

27. The method of claim 26, wherein generating the report comprises generating the report such that the report comprises:
a summary of each emerging topic; and
for at least one emerging topic in the report, a link to an audio file that, when played, provides an audible example of a call to the call center pertaining to the at least one emerging topic.
